(19) United States
(12) Patent Application Publication
(10) Pub. No.: US 2008/0094756 A1
(43) Pub. Date: Apr. 24, 2008

(54) Carriage assembly of a hard disk drive

(75) Inventors: Kenichi Makino, Kanagawa (JP); Atsuo Makino, Kanagawa (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/001,861

(22) Filed: Dec. 13, 2007

Related U.S. Application Data
(63) Continuation of application No. PCT/JP2005/011903, filed on Jun. 29, 2005.

(51) Int. Cl. G11B 5/48

(52) U.S. Cl. 360/245.9

(57) ABSTRACT

There is provided a carriage assembly of a hard disk drive where a convex pattern that makes it possible to mount a magnetic head with high precision in parallel on a gimbal is provided on the gimbal and where it is possible to use the same convex pattern regardless of whether a U-shaped pressing member is used or a pressing member shaped like geta teeth is used as the pressing member when mounting the magnetic head on the gimbal, which makes it unnecessary to redesign the convex pattern in accordance with the construction of a magnetic disk and thereby reduces the design cost. Joining portions, which are composed of part of the wiring circuit and are used to join the connection terminals of the magnetic head, and two protruding bar-shaped portions, which support the magnetic head and are formed along both edges of a bonding portion of the gimbal for the magnetic head that are perpendicular to an end surface of the magnetic head where the connection terminals are formed, are formed on the surface of the gimbal on which the wiring circuit is formed. The magnetic head is bonded to the bonding portion by adhesive applied between the two protruding bar-shaped portions of the bonding portion.

### TECHNICAL FIELD

The present invention relates to a carriage assembly of a hard disk drive including a carriage main body that is provided so as to be rotatable around an actuator shaft, a load beam that extends from the carriage main body in a direction perpendicular to the actuator shaft, a flexure that is supported in parallel with the load beam and has a wiring circuit formed on a surface thereof, a gimbal that is formed so as to be cantilevered on the front end of the flexure, wherein an opposite side of the gimbal to the surface on which the wiring circuit is formed contacts and is supported by a protruding portion formed on the load beam, and a substantially rectangular magnetic head that is bonded to a bonding portion on the surface of the gimbal on which the wiring circuit is formed and electrically connected to the wiring circuit via connection terminals formed on an end surface of the magnetic head.

### BACKGROUND ART

The construction of a carriage assembly of a conventional hard disk drive (or “magnetic disk apparatus”) and a method of attaching a magnetic head (or “slider”) to a gimbal during the manufacturing of the same are described below.

FIGS. 3A and 3B are diagrams useful in explaining a carriage assembly C1 of a hard disk drive, with FIG. 3A being a plan view where the carriage assembly C1 is viewed from a direction perpendicular to the magnetic disk surface of a hard disk drive, not shown, and FIG. 3B being a view where a load beam 4 that constructs the carriage assembly C1 is viewed from the same side as the surface that faces the magnetic disk (i.e., from the rear surface side of the load beam 4 shown in FIG. 3A).

The carriage assembly C1 includes a carriage main body 2 in which is formed a hole 2a for inserting and attaching an actuator shaft of a hard disk drive main body, not shown, and is provided so as to be rotatable about the actuator shaft, the load beam 4 that extends from the carriage main body 2 in a direction perpendicular to the actuator shaft (i.e., the axis of the hole 2a), a flexure 6 that is supported in parallel with the load beam 4 and has a wiring circuit 6a are formed on one surface thereof (the surface that faces a magnetic disk), and a gimbal 6b formed at a front end of the flexure 6.

FIG. 4 is an enlarged view showing the gimbal 6b of the flexure 6 and a periphery thereof when view from the same side of the flexure 6 as the surface on which the wiring circuit 6a is formed (the “one surface” mentioned above). The gimbal 6b is formed from the same member as the flexure 6 but is formed in an island-like shape by cutting out the gimbal 6b from the main body of the flexure 6. The gimbal 6b is formed in a cantilevered shape where only a part 6c of the gimbal 6b on the front-end side of the flexure 6 is connected to the main body of the flexure 6.

Joining portions 6e composed of parts of the wiring circuit 6a are formed on the gimbal 6b for joining connection terminals 8a of a magnetic head 8, described later. The wiring circuit 6a is constructed of a conductive layer formed in a predetermined wiring pattern and the surface of the conductive layer is covered with an insulating film of polyimide or the like. The joining portions 6e are formed by removing the insulating film from the wiring circuit 6a only at certain positions to expose the conductive layer below.

FIG. 5 is a side view showing the construction of the periphery of the gimbal 6b.

The gimbal 6b is supported by a protruding portion 4a formed on the load beam 4 from the opposite surface to the surface of the flexure 6 on which the wiring circuit 6a is formed. By doing so, the cantilevered gimbal 6b is favorably supported without movement of the gimbal 6b that follows the magnetic disk surface being obstructed.

In addition, the magnetic head 8 is mounted on the gimbal 6b. The magnetic head 8 is mounted by bonding with adhesive 10 to a bonding portion 6d (shown by the broken line in FIG. 4) on the surface of the gimbal 6b that faces the magnetic disk (i.e., the surface on which the wiring circuit 6a is formed).

As shown in FIG. 5, connection terminals 8a that are to be electrically joined to the joining portions 6e of the wiring circuit 6a are formed on one end surface of the magnetic head 8. The magnetic head 8 is disposed on the gimbal 6b so that an edge of such end surface is placed on the insulating film. The joining portions 6e on the wiring circuit 6a and the connection terminals 8a of the magnetic head 8 are electrically connected by forming metal balls 12 to join the wiring circuit 6a and the magnetic head 8.

When the magnetic head 8 is bonded on the gimbal 6b and the two are joined by the metal balls 12, it is necessary to press the opposite surface of the gimbal 6b to the surface on which the magnetic head is mounted to prevent the gimbal 6b from becoming deformed by the pressure applied during the bonding and joining. FIG. 6 is a view showing a state where the opposite surface of the gimbal 6b to the surface on which the magnetic head is mounted is pressed using a pressing member 50 during the bonding of the magnetic head 8 and joining with the metal balls 12.

In this carriage assembly C1, the front end of the load beam 4 is formed so as to extend as far as a position that coincides with the gimbal 6b and is also tapered so that the gimbal 6b can be supported with the protruding portion 4a formed on the front end of the load beam 4. Accordingly, as shown in FIG. 6, the pressing member 50 is formed in a U shape so as to avoid the front end of the load beam 4.

The carriage assembly C1 described above is used in a hard disk drive of a type where the magnetic head 8 is always positioned above the magnetic disk surface. On the other hand, with a hard disk drive used in a mobile appliance such as a laptop computer, since the drive is subjected to shaking and the like during carrying, a construction is used where the magnetic head 8 is withdrawn (or “unloaded”) from the magnetic disk surface when the hard disk drive is not in use.

FIGS. 7A and 7B are diagrams useful in explaining a carriage assembly C2 of a hard disk drive with an unload function, with FIG. 7A being a plan view where the carriage assembly C2 is viewed from a direction perpendicular to the magnetic disk surface of a hard disk drive, not shown, and FIG. 7B being a view where a load beam 5 that constructs the carriage assembly C2 is viewed from the same side as the surface that faces the magnetic disk (i.e., from the rear surface side of the lode beam 5 shown in FIG. 7A). Note that the components in the construction of the carriage assembly C2 that are the same as in the carriage assembly C1 described above have been assigned the same reference numerals and description thereof has been omitted.

With the carriage assembly C2 also, a protruding portion 5a is formed on the load beam 5 to support the gimbal 6b from the opposite side to the surface on which the magnetic head 8 is mounted.

Also, with the carriage assembly C2, unlike the carriage assembly C1, the front end of the load beam 5 protrudes beyond the front end of the flexure 6 to form a tab 5d. The tab 5d is formed so that when the magnetic head 8 has been unloaded from the magnetic disk surface, the carriage assembly C2 can be held at the unload position by supporting the tab 5d.

When the front end of the load beam 5 is formed so as to protrude beyond the front end of the flexure 6 as in the carriage assembly C2, openings 5b, 5c for supporting the gimbal 6b from the opposite surface to the surface on which the magnetic head 8 is mounted during the mounting of the magnetic head 8 on the gimbal 6b are formed in the load beam 5 (see FIG. 7A). The two openings 5b, 5c are formed both in front of and behind the protruding portion 5a, which is formed at a position so as to contact a central periphery of the gimbal 6b.

When the magnetic head 8 is mounted on the gimbal 6b, a pressing member 52 shaped like geta teeth¹ so as to correspond to the openings 5b, 5c is placed in contact with the opposite surface of the gimbal 6b to the surface on which the magnetic head 8 is mounted via the openings 5b, 5c to support the gimbal 6b (see FIG. 7A).
¹geta are traditional Japanese wooden clogs composed of a flat board with two downward protruding supports or “teeth” positioned at the ball and near the heel of the foot.

A predetermined convex pattern has conventionally been formed on the bonding portion 6d of the gimbal 6b to improve the bond between the gimbal 6b and the magnetic head 8.

As one example, a technique that forms a plurality of circular or oval convex patterns (“pads”) on the entire bonding surface (mounting portion) of the gimbal is disclosed in Patent Document 1. According to this technique, concave portions between the pads are filled with adhesive so that the magnetic head (“slider”) is strongly bonded (see Paragraph 0023 and FIG. 2 of Patent Document 1).

Patent Document 1

Japanese Laid-Open Patent Publication No. 11-149625 (see FIG. 2 and Paragraph 0023)

### DISCLOSURE OF THE INVENTION

However, if a construction is used where a plurality of circular or oval pads are formed on the entire bonding surface of the gimbal as in the background art, when adhesive is applied to the bonding surface, the adhesive will also adhere onto the pads, so that as shown in FIG. 5, there is the problem of adhesive 10 between the pads 14 and the magnetic head 8 preventing the magnetic head 8 from becoming parallel to the surface of the gimbal 6b, resulting in the magnetic head 8 being inclined.

If the magnetic head is attached to the gimbal in an inclined state, problems may occur such as deterioration in the precision of accesses to the magnetic disk by the magnetic head.

The present invention was conceived to solve the problem described above and it is an object of the present invention to provide a carriage assembly of a hard disk drive where a convex pattern that makes it possible to mount a magnetic head with high precision in parallel on a gimbal is provided on the gimbal and where it is possible to use the same convex pattern regardless of whether a U-shaped pressing member is used or a pressing member shaped like geta teeth is used as the pressing member when mounting the magnetic head on the gimbal, which makes it unnecessary to redesign the convex pattern in accordance with the construction of a magnetic disk and thereby reduces the design cost.

To achieve the stated object, a carriage assembly of a hard disk drive according to the present invention includes: a carriage main body that is provided so as to be rotatable around an actuator shaft; a load beam that extends from the carriage main body in a direction perpendicular to the actuator shaft; a flexure that is supported in parallel with the load beam and has a wiring circuit formed on a surface thereof; a gimbal that is formed so as to be cantilevered on a front end of the flexure, wherein an opposite side of the gimbal to the surface on which the wiring circuit is formed contacts and is supported by a protruding portion formed on the load beam; and a magnetic head that is substantially rectangular, is bonded to a bonding portion on the surface of the gimbal on which the wiring circuit is formed, and is electrically connected to the wiring circuit via connection terminals formed in one end surface of the magnetic head, wherein joining portions that are composed of parts of the wiring circuit and are used to join the connection terminals of the magnetic head, and two protruding bar-shaped portions that are formed along both edges of the bonding portion that are perpendicular to the one end surface of the magnetic head and support the magnetic head are formed on the surface of the gimbal on which the wiring circuit is formed, and the magnetic head is bonded to the bonding portion by adhesive applied between the two protruding bar-shaped portions of the bonding portion.

In addition, a surface of the wiring circuit may be covered with an insulating film, the joining portions may be formed by exposing part of the wiring circuit from the insulating film, the magnetic head may be disposed on the gimbal so that an edge of the one end surface is on the insulating film, and the protruding bar-shaped portions may be formed with a height that is equal to the height of a surface of the insulating film relative to the gimbal so that a bonding surface of the magnetic head becomes parallel with the gimbal.

With this construction, by applying the adhesive between the two protruding bar-shaped portions as the convex pattern, it is possible to bond the magnetic head on the protruding bar-shaped portions in parallel with the gimbal without the magnetic head becoming inclined due to adhesive adhering on the convex pattern. In addition, if a U-shaped pressing member is used when the magnetic head is mounted, the pressure applied to the gimbal can be favorably supported by a U-shaped part formed by the joining portions of the wiring circuit and the two protruding bar-shaped portions. Alternatively, if the gimbal is supported at two positions using a pressing member shaped like geta teeth, one of the geta teeth will press positions corresponding to the joining portions and both ends of the other geta tooth will press positions corresponding to the protruding bar-shaped portions so that it is possible to favorably support the pressure applied to the gimbal. Accordingly, it is possible to design a common convex pattern for when a U-shaped pressing member is used and when a pressing member shaped like geta teeth is used, which makes it possible to reduce the design cost.

Also, a convex portion for supporting the magnetic head may be formed at a position on the surface of the gimbal on which the wiring circuit is formed that corresponds to a rear surface of a position contacted by the protruding portion, and the adhesive may be applied at two positions that are aligned in a length direction of the bar-shaped protruding portions and are located on both sides of the convex portion.

By doing so, it is possible to favorably transmit the bearing force provided by the protruding portion of the load beam via the convex portion to the magnetic head and to bond the magnetic head in parallel with the gimbal without adhesive being applied on the protruding bar-shaped portions or the convex portion.

The bar-shaped protruding portions may be composed of a same construct as the wiring circuit.

With this construction, the process of forming the wiring pattern on the flexure and the process of forming the protruding bar-shaped portions can be completed in the same process, which makes it possible to reduce the number of manufacturing steps.

Also, at least one gap may be formed in at least one of the protruding portions, and a conductive material that forms a conductive path between the gimbal and the magnetic head may be applied in at least one of the at least one gaps of the protruding bar-shaped portions.

With this construction, it is possible to provide a position for applying the conductive material that allows static electricity produced in the magnetic head to escape to the flexure.

### EFFECT OF THE INVENTION

With the carriage assembly of a hard disk drive according to the present invention, a convex pattern that makes it possible to mount a magnetic head with high precision in parallel on a gimbal is provided on the gimbal, and it is possible to use the same convex pattern regardless of whether a U-shaped pressing member is used or a pressing member shaped like geta teeth is used as the pressing member when mounting the magnetic head on the gimbal, which makes it unnecessary to redesign the convex pattern in accordance with the construction of a magnetic disk and thereby reduces the design cost.

### BRIEF DESCRIPTION OF THE DRAWINGS

FIG. 1 is a diagram useful in explaining the construction of a mounting surface for a magnetic head on a gimbal in a carriage assembly of a hard disk drive according to the present invention.

FIG. 2 is a diagram useful in explaining the construction of a mounting surface for a magnetic head on a gimbal in a carriage assembly of a hard disk drive according to the present invention.

FIG. 3A is a plan view when looking from a direction perpendicular to a magnetic disk surface of a hard disk drive and FIG. 3B is a view where a load beam that constructs a carriage assembly is viewed from the same side as a surface that faces a magnetic disk (i.e., from the rear surface side of the load beam shown in FIG. 3A).

FIG. 4 is an enlarged view of the gimbal and a periphery thereof.

FIG. 5 is a side view showing the construction of the periphery of the gimbal.

FIG. 6 is a diagram useful in explaining a state where an opposite surface of the gimbal to the surface on which the magnetic head is mounted is pressed with a pressing member when carrying out bonding of the magnetic head and joining using metal balls.

FIG. 7A is a plan view when looking from a direction perpendicular to a magnetic disk surface of a hard disk drive and FIG. 7B is a view where a load beam that constructs a carriage assembly is viewed from the same side as a surface that faces a magnetic disk (i.e., from a rear surface side of the load beam shown in FIG. 7A).

### BEST MODE FOR CARRYING OUT THE INVENTION

A preferred embodiment of the present invention will now be described in detail with reference to the attached drawings.

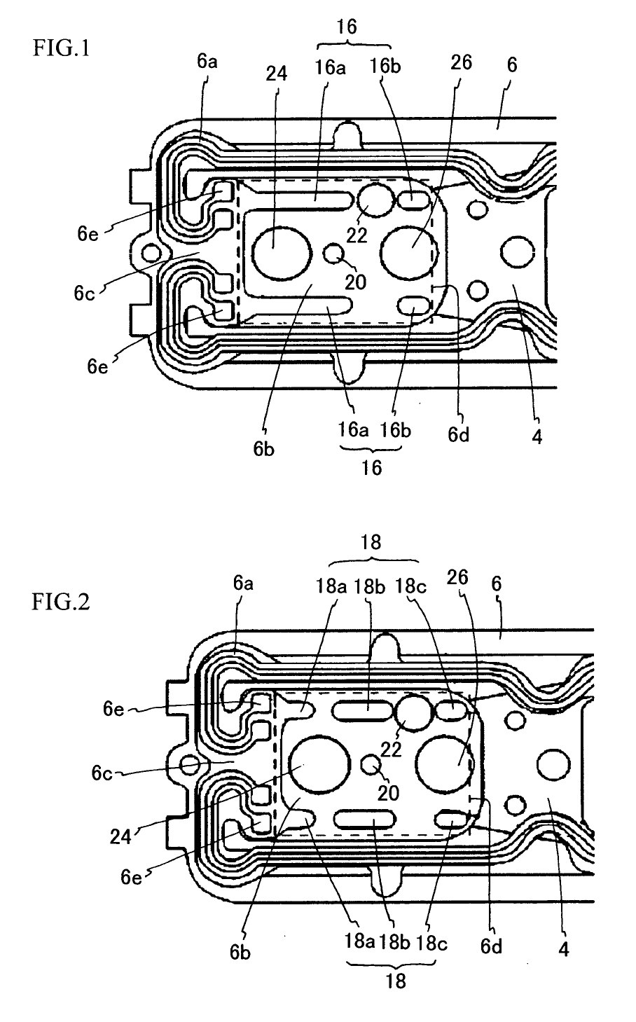

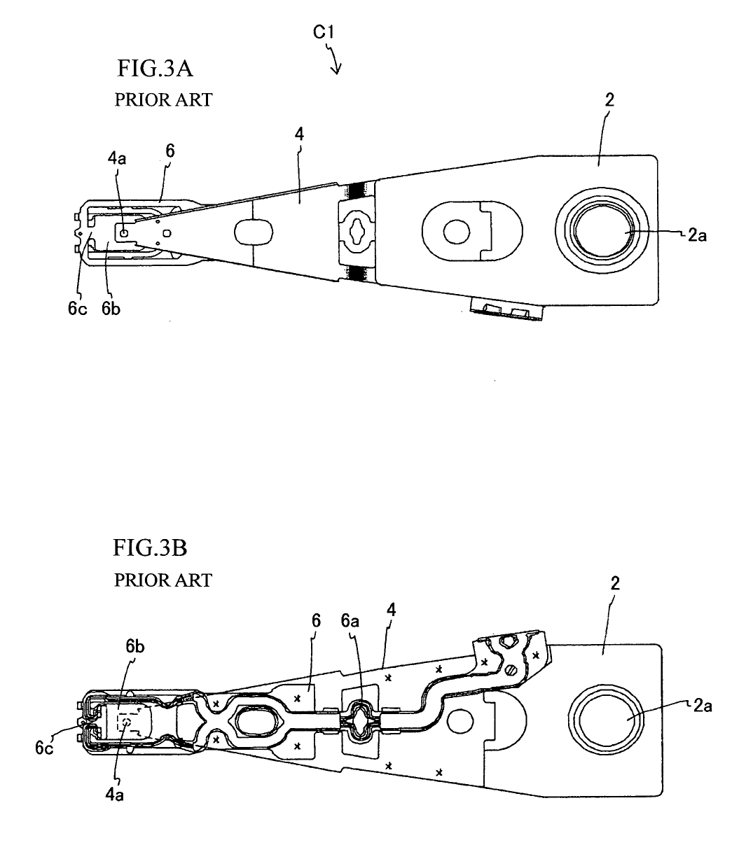

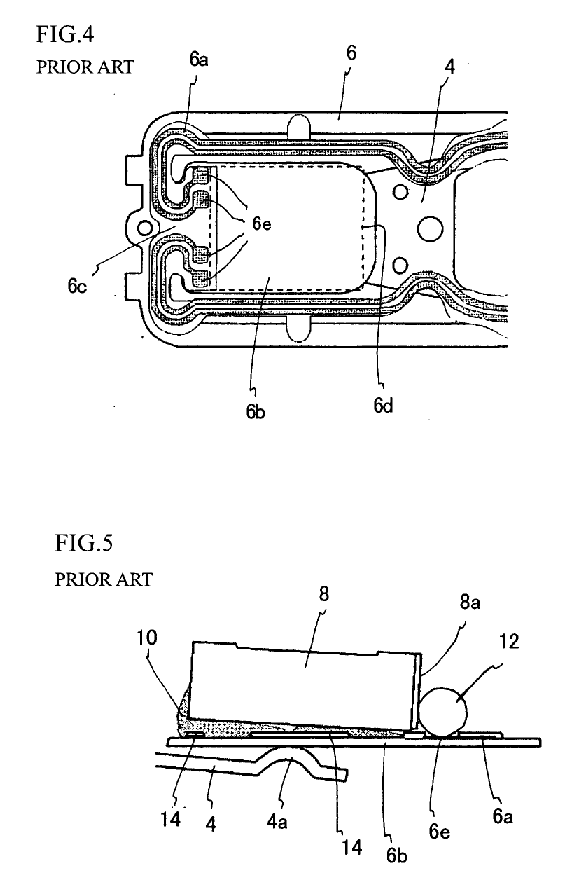

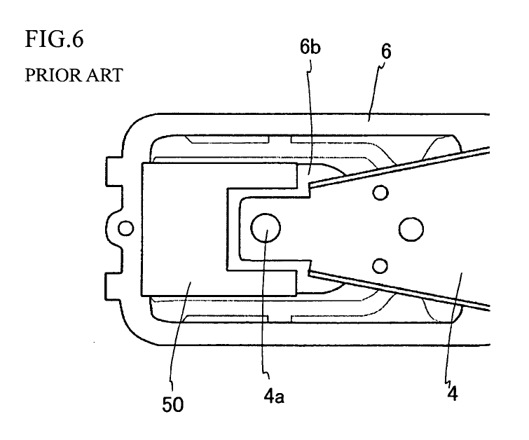

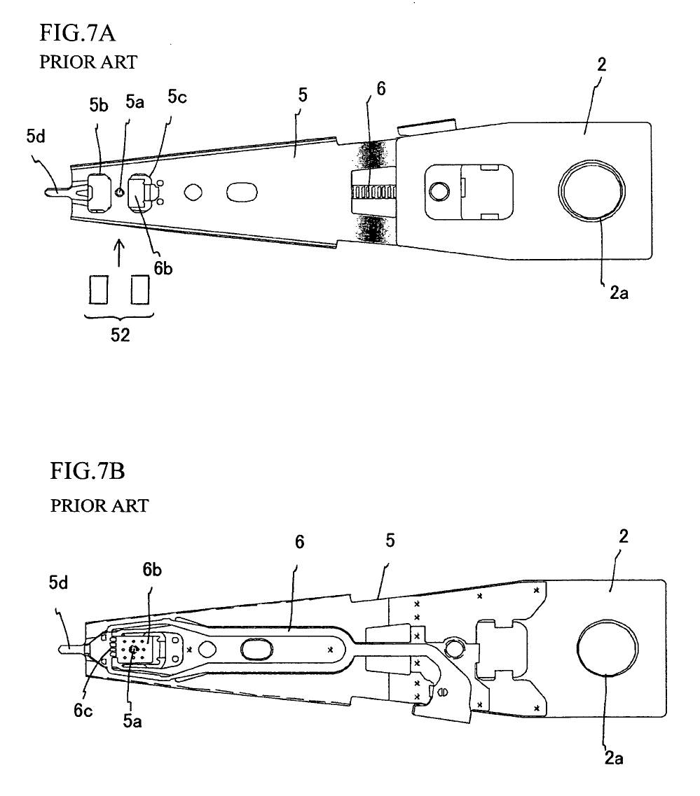

FIG. 1 is a diagram useful in explaining a mounting surface for a magnetic head 8 on a gimbal 6b in a carriage assembly of a hard disk drive according to the present embodiment. Note that since the other components of the carriage assembly according to the present embodiment are the same as in the carriage assembly C1 or C2 described in the background art and shown in FIGS. 3A and 3B to FIGS. 7A and 7B, description thereof has been omitted.

As shown in FIG. 1, joining portions 6e, which are composed of parts of the wiring circuit 6a and are used to join the connection terminals 8a (not shown in FIG. 1) of the magnetic head 8, are formed on the surface of the gimbal 6b of the carriage assembly according to the present embodiment on which the wiring circuit 6a is formed (i.e., on the bonding portion 6d).

In addition, two rows of protruding bar-shaped portions 16, 16 are formed on both edges of the bonding portion 6d of the gimbal 6b that are perpendicular to the end surface where the connection terminals 8a of the magnetic head 8 are formed (i.e., perpendicular to the joining portions 6e). The protruding bar-shaped portions 16, 16 are each formed with a gap so as to be divided at a midpoint into a part 16a that extends from the periphery of the joining portions 6e and a part 16b located further beyond.

A small circular convex portion 20 is formed at a position in the bonding portion 6d that corresponds to a position contacted by the protruding portion 5a of the load beam 5 (i.e., in substantially the center of the gimbal 6b).

The protruding bar-shaped portions 16, 16 and the convex portion 20 are constructed of the same material as the wiring circuit 6a and are formed in the same process as the formation of the wiring circuit 6a. That is, the lower layer is composed of a conductive layer made of metal or the like and the surface of the conductive layer is covered with an insulating film of polyimide or the like.

Accordingly, the protruding bar-shaped portions 16, 16 and the convex portion 20 are formed with the same height as the height of the surface of the wiring circuit 6a (i.e., the surface of the insulating film) relative to the surface of the gimbal 6b.

Adhesive 24, 26 for bonding the magnetic head 8 to the gimbal 6b is applied at two positions that are between the two protruding bar-shaped portions 16, 16 on the bonding portion 6d and are aligned in the length direction of the protruding bar-shaped portions 16, 16 on both sides of the convex portion 20.

In addition, to allow static electricity produced in the magnetic head 8 to escape to the flexure 6, a conductive material 22 for forming an electrically conductive path between the gimbal 6b and the magnetic head 8 is applied to a gap in a protruding bar-shaped portion 16 (a part where the protruding bar-shaped portion is separated), or in other words, to the gap between the parts 16a and 16b of the protruding bar-shaped portion.

In a state where a U-shaped pressing member 50 or a pressing member 52 shaped like geta teeth is pressed against the rear surface of the bonding portion 6d of the gimbal 6b, the magnetic head 8 is bonded to the bonding surface to which the adhesive 24, 26 and the conductive material 22 have been applied. Also, by forming the metal balls 12 that join the joining portions 6e on the wiring circuit 6a and the connection terminals 8a of the magnetic head 8, the magnetic head 8 is electrically connected (see FIG. 5).

With the carriage assembly with a convex pattern on the gimbal 6b according to the present embodiment, by applying the adhesive 24, 26 between the two protruding bar-shaped portions 16, 16 as the convex pattern, since no adhesive will adhere onto the convex pattern, it is possible to bond the magnetic head 8 on the protruding bar-shaped portions 16, 16 in parallel with the gimbal 6b without the magnetic head 8 becoming inclined. In addition, if a U-shaped pressing member is used when the magnetic head 8 is mounted, the pressure applied to the gimbal 6b can be favorably supported by a U-shaped part composed of the joining portions 6e of the wiring circuit 6a and the parts 16a, 16a of the two protruding bar-shaped portions 16, 16. Alternatively, if the gimbal 6b is supported at two positions using a pressing member shaped like geta teeth, one of the geta teeth will press positions corresponding to the joining portions 6e and both ends of the other geta tooth will press positions corresponding to parts 16b, 16b of the protruding bar-shaped portions 16, 16, so that it is possible to favorably support the pressure applied to the gimbal 6b. Accordingly, by using this convex pattern, it is possible to cope both when a U-shaped pressing member is used and when a pressing member shaped like geta teeth is used, so that there is no need to change the design of the convex pattern in accordance with the shape of the pressing member used during bonding and joining, which makes it possible to reduce the design cost.

In addition, since the protruding bar-shaped portions 16, 16 are formed at the edges of the bonding portion 6d and do not occupy a large area of the bonding portion 6d (i.e., the gimbal 6b), even if the convex portion 20 corresponding to the protruding portion 5a is provided in substantially the center of the gimbal 6b, it will still be possible to provide sufficient space for applying the adhesive 24, 26 at two positions that are aligned in the length direction of the protruding bar-shaped portions 16, 16 on both sides of the convex portion 20 without the adhesive being applied onto the convex pattern.

In addition, since the applied position of the conductive material 22 used to allow static electricity produced in the magnetic head 8 to escape to the flexure is provided in a gap of one protruding bar-shaped portion 16, it is possible to apply the conductive material 22 without the conductive material 22 being applied onto the convex pattern, while still leaving sufficient space for applying the adhesive 24, 26.

Note that with the present embodiment, although both the protruding bar-shaped portions 16, 16 are formed with gaps so as to be split at midpoints thereof, since it is sufficient to apply the conductive material to only one position, only one out of the protruding bar-shaped portions 16, 16 may be formed with a gap.

The construction of a carriage assembly of a hard disk drive according to the present invention is not limited to the embodiment described above.

For example, as shown in FIG. 2, gaps may be provided at two positions in protruding bar-shaped portions 18, 18 to split the protruding bar-shaped portions 18, 18 into three parts 18a, 18b, 18c.

Also, it is not necessary to form the part of the wiring circuit 6a in the periphery of the joining portions 6e and the protruding bar-shaped portions 16, 16 as continuous, and the peripheral part and the protruding bar-shaped portions 16, 16 may be formed slightly apart.

What is claimed is:

1. A carriage assembly of a hard disk drive comprising:
a carriage main body that is provided so as to be rotatable around an actuator shaft;
a load beam that extends from the carriage main body in a direction perpendicular to the actuator shaft;
a flexure that is supported in parallel with the load beam and has a wiring circuit formed on a surface thereof;
a gimbal that is formed so as to be cantilevered on a front end of the flexure, wherein an opposite side of the gimbal to the surface on which the wiring circuit is formed contacts and is supported by a protruding portion formed on the load beam; and
a magnetic head that is substantially rectangular, is bonded to a bonding portion on the surface of the gimbal on which the wiring circuit is formed, and is electrically connected to the wiring circuit via connection terminals formed in one end surface of the magnetic head,
wherein
joining portions that are composed of parts of the wiring circuit and are used to join the connection terminals of the magnetic head, and
two protruding bar-shaped portions that are formed along both edges of the bonding portion that are perpendicular to the one end surface of the magnetic head and support the magnetic head
are formed on the surface of the gimbal on which the wiring circuit is formed, and
the magnetic head is bonded to the bonding portion by adhesive applied between the two protruding bar-shaped portions of the bonding portion.

2. A carriage assembly of a hard disk drive according to claim 1,
wherein a surface of the wiring circuit is covered with an insulating film,
the joining portions are formed by exposing part of the wiring circuit from the insulating film,
the magnetic head is disposed on the gimbal so that an edge of the one end surface is on the insulating film, and
the protruding bar-shaped portions are formed with a height that is equal to the height of a surface of the insulating film relative to the gimbal so that a bonding surface of the magnetic head becomes parallel with the gimbal.

3. A carriage assembly of a hard disk drive according to claim 1,
wherein a convex portion for supporting the magnetic head is formed at a position on the surface of the gimbal on which the wiring circuit is formed that corresponds to a rear surface of a position contacted by the protruding portion, and
the adhesive is applied at two positions that are aligned in a length direction of the bar-shaped protruding portions and are located on both sides of the convex portion.

4. A carriage assembly of a hard disk drive according to claim 1,
wherein the bar-shaped protruding portions are composed of a same construct as the wiring circuit.

5. A carriage assembly of a hard disk drive according to claim 1,
wherein at least one gap is formed in at least one of the protruding portions, and
a conductive material that forms a conductive path between the gimbal and the magnetic head is applied in at least one of the at least one gaps of the protruding bar-shaped portions.
